(19) United States
(12) Patent Application Publication
(10) Pub. No.: US 2024/0179288 A1
(43) Pub. Date: May 30, 2024

(54) 3D PROJECTION METHOD AND 3D PROJECTION DEVICE

(71) Applicant: Coretronic Corporation, Hsin-Chu (TW)

(72) Inventors: Wen-Bin Chien, Hsin-Chu (TW); Te-Sung Su, Hsin-Chu (TW); Wei-Chia Lai, Hsin-Chu (TW); Yen-Yu Chou, Hsin-Chu (TW)

(73) Assignee: Coretronic Corporation, Hsin-Chu (TW)

(21) Appl. No.: 18/513,630

(22) Filed: Nov. 20, 2023

(30) Foreign Application Priority Data
Nov. 24, 2022 (CN) 202211483294.9

(51) Int. Cl. H04N 13/302; G02B 30/22; H04N 13/363

(52) U.S. Cl. CPC H04N 13/302; G02B 30/22; H04N 13/363

(57) ABSTRACT

A 3D projection method and a 3D projection device are provided. The method includes: obtaining first and second eye images, wherein the first and second eye images respectively includes multiple first and second pixel groups, and each first and second pixel group includes a first, second, third, and fourth pixel; respectively generating a first and third projection image based on the first and third pixel of the first pixel group; respectively generating a second and fourth projection image based on the second and fourth pixel of the second pixel group; and sequentially projecting the first, second, third and fourth projection images. The first and third projection images correspond to the first eye image, the second and fourth projection images correspond to the second eye image, and the first and second eye images are respectively one and another of the left eye image and the right eye image.

### CROSS-REFERENCE TO RELATED APPLICATION

This application claims the priority benefit of China application serial no. 202211483294.9, filed on Nov. 24, 2022. The entirety of the above-mentioned patent application is hereby incorporated by reference herein and made a part of this specification.

### BACKGROUND

### Technical Field

The disclosure relates to a projection mechanism, and in particular relates to a 3D projection method and a 3D projection device.

### Description of Related Art

With the improvement of the manufacturing technology of display panels, the resolution of a display panel on the market has been increased from the original 2K (i.e., 1920*1080) resolution to 4K (i.e., 3840*2160) resolution. However, for projectors, the rate of improvement in resolution is relatively slow. In the conventional technology, current projectors use a 1920*1080 or 2712*1528 digital micromirror device (DMD) with a four-way (4Way) or two-way (2Way) actuator to achieve 4K resolution, that is, an extended pixel resolution (XPR) technology in digital light processing (DLP) is used. Although the image quality produced by DLP XPR technology is still far behind that of native 4K, it may greatly reduce the cost of 4K projectors.

In the case of general 2D projection, a 1920*1080 DMD with a four-way actuator may achieve a resolution of 4K60 Hz. However, in a 3D projection scenario where left and right eye images need to be presented, the current upper limit of XPR development is a bandwidth of only 600 MHz per unit time, and the corresponding upper limit of resolution and frequency is about 2200*1125 and 60 Hz. In other words, XPR may only support image information such as 4K (3840*2160) and 60 Hz, or 2K HD (1920*1080) and 240 Hz, whose total resolution information is below 600 MHz. However, when performing 3D projection, the frequency is required to be higher than 120 Hz. In this case, a trade-off between frequency and resolution is required, and both parameters cannot be raised to the highest.

In addition, in the conventional art, there is also a practice of disabling the image processing function of the XPR, not driving the actuator, and directly outputting images with the preset native DMD resolution. However, since the current resolution limit supported by the DMD is 2K, when encountering an input image signal with a resolution exceeding 2K, the image is required to be compressed, resulting in a decrease in resolution.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY

An embodiment of the present disclosure provides a 3D projection method suitable for a 3D projection device, including the following operation. A first eye image and a second eye image are obtained, in which the first eye image includes multiple first pixel groups, the second eye image includes multiple second pixel groups. Each of the first pixel groups and each of the second pixel groups includes a first pixel, a second pixel, a third pixel, and a fourth pixel. A first projection image is generated based on the first pixels of the first pixel groups. A second projection image is generated based on the second pixels of the second pixel groups. A third projection image is generated based on the third pixels of the first pixel groups. A fourth projection image is generated based on the fourth pixels of the second pixel groups. The first projection image, the second projection image, the third projection image, and the fourth projection image are sequentially projected. The first projection image and the third projection image correspond to the first eye image, the second projection image and the fourth projection image correspond to the second eye image, the first eye image is one of a left eye image and a right eye image, and the second eye image is another one of the left eye image and the right eye image.

An embodiment of the present disclosure provides a 3D projection device, including an image processing device and an image shifting device. The image processing device is configured to perform the following operation. A first eye image and a second eye image are obtained, in which the first eye image includes multiple first pixel groups, the second eye image includes multiple second pixel groups, and each of the first pixel groups and each of the second pixel groups includes a first pixel, a second pixel, a third pixel, and a fourth pixel. A first projection image is generated based on the first pixels of the first pixel groups. A second projection image is generated based on the second pixels of the second pixel groups. A third projection image is generated based on the third pixels of the first pixel groups. A fourth projection image is generated based on the fourth pixels of the second pixel groups. The image shifting device is coupled to the image processing device and is configured to perform the following operation. The first projection image, the second projection image, the third projection image, and the fourth projection image are sequentially projected. The first projection image and the third projection image correspond to the first eye image, the second projection image and the fourth projection image correspond to the second eye image, the first eye image is one of a left eye image and a right eye image, and the second eye image is another one of the left eye image and the right eye image.

In order to make the above-mentioned and other objects, features and advantages of the present disclosure comprehensible, preferred embodiments accompanied with drawings are described in detail below.

Other objectives, features and advantages of the present disclosure will be further understood from the further technological features disclosed by the embodiments of the present disclosure wherein there are shown and described preferred embodiments of this disclosure, simply by way of illustration of modes best suited to carry out the disclosure.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic diagram of a 3D projection device according to an embodiment of the present disclosure.

FIG. 2 is a flowchart of a 3D projection method according to an embodiment of the present disclosure.

FIG. 3 is a schematic diagram of a first eye image and a second eye image according to an embodiment of the present disclosure.

FIG. 4 is a schematic diagram of generating a projection image based on the first eye image and the second eye image shown in FIG. 3.

FIG. 5A to FIG. 5D are schematic diagrams of projecting multiple projection images according to FIG. 4.

FIG. 6 is a schematic diagram of sequentially projecting multiple projection images according to FIG. 5A to FIG. 5D.

### DETAILED DESCRIPTION OF DISCLOSED EMBODIMENTS

It is to be understood that other embodiment may be utilized and structural changes may be made without departing from the scope of the present disclosure. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

The above and other technical contents, features and effects of the disclosure will be clear from the below detailed description of an embodiment of the disclosure with reference to accompanying drawings. The directional terms mentioned in the embodiments below, like “above”, “below”, “left”, “right”, “front”, and “back”, refer to the directions in the appended drawings. Therefore, the directional terms are used to illustrate rather than limit the disclosure.

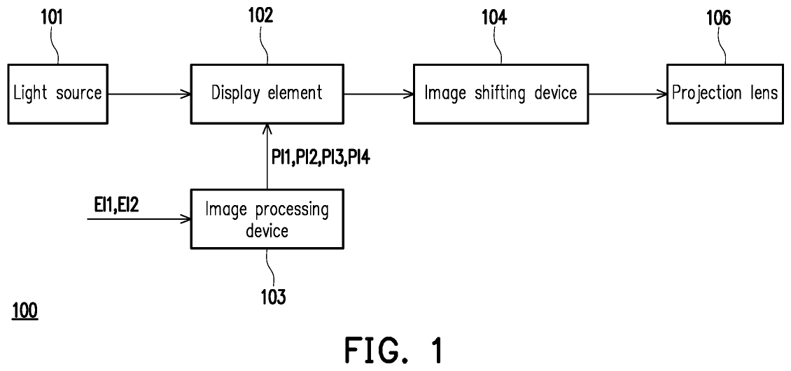

Referring to FIG. 1, FIG. 1 is a schematic diagram of a 3D projection device according to an embodiment of the present disclosure. In the embodiment of the present disclosure, the 3D projection device 100 is, for example, a 3D projector capable of 3D projection.

In FIG. 1, a 3D projection device 100 may include a light source 101, a display element 102, an image processing device 103, an image shifting device 104, and a projection lens 106. The light source 101 may generate light beams, and the light beams may be guided to the display element 102, so that the display element 102 modulates the received light beams in response to the image data provided by the image processing device 103 to form a projection image.

In FIG. 1, the image processing device 103 may be a general purpose processor, a special purpose processor, a conventional processor, a digital signal processor, multiple microprocessors, one or more combined digital signal processing microprocessor, a controller, a microcontroller, an application specific integrated circuit (ASIC), a field programmable gate array (FPGA), any other type of integrated circuit, state machine, advanced RISC machine (ARM) based processor or the like.

In one embodiment, the image shifting device 104 is, for example, an XPR device, which may shift the projection image provided by the display element 102 to a specific position through a multi-way (for example, four-way or two-way) actuator, and the projection image shifted to a specific position may then be projected onto a projection surface such as a projection screen or a wall through the projection lens 106.

In one embodiment, the display element 102 may be a spatial light modulator, such as a DMD, which may be, for example, controlled by a distributed data processor (DDP) (not shown) in the 3D projection device 101 to adjust the configuration of the micromirror matrix, but not limited thereto.

In one embodiment, the 3D projection device 100 may be connected to 3D glasses that may be worn by the user through wired or wireless methods, and may control the enabling or disabling of the first lens and the second lens of the 3D glasses when performing 3D projection. For example, when the 3D projection device 100 projects a projection image corresponding to the first eye (e.g., the left eye), the 3D projection device 100 may enable the first lens (e.g., the left eye lens) and disable the second lens (e.g., the right eye lens) of the 3D glasses, so that the projection image corresponding to the first eye enters the first eye of the user through the first lens after being reflected by a projection surface such as a projection screen or a wall, and that the projection image corresponding to the first eye is reflected by the projection surface such as a projection screen or a wall, and then is blocked by the second lens and cannot enter the second eye (e.g., the right eye) of the user. In this way, the user may only use the first eye to see the projection image corresponding to the first eye. In addition, when the 3D projection device 100 projects a projection image corresponding to the second eye, the 3D projection device 100 may enable the second lens and disable the first lens of the 3D glasses, so that the projection image corresponding to the second eye enters the second eye of the user through the second lens after being reflected by a projection surface such as a projection screen or a wall, and that the projection image corresponding to the second eye is reflected by the projection surface such as a projection screen or a wall, and then is blocked by the first lens and cannot enter the first eye of the user. In this way, the user may only use the second eye to see the projection image corresponding to the second eye.

In the embodiment of the present disclosure, the 3D projection device 100 may project the projection images corresponding to the left and right eyes at a frequency not lower than 120 Hz by implementing the 3D projection method provided by the present disclosure, so as to achieve the effect of residual vision in the eyes of the user, thereby the user may enjoy the experience of viewing 3D projection content. This is further described below.

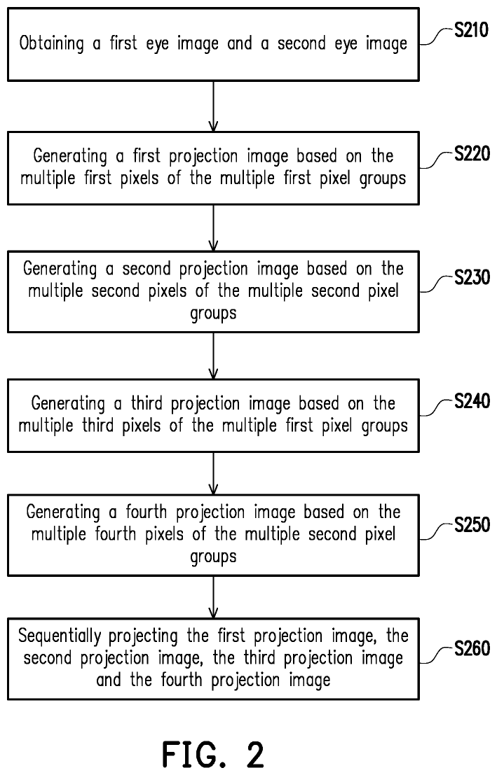

Referring to FIG. 2, FIG. 2 is a flowchart of a 3D projection method according to an embodiment of the present disclosure. The method of this embodiment may be executed by the 3D projection device 100 in FIG. 1 after being configured, and the details of each step in FIG. 2 will be described below with reference to the elements shown in FIG. 1.

First, in step S210, the image processing device 103 obtains the first eye image EI1 and the second eye image EI2. In the embodiment of the present disclosure, the first eye image EI1 is one of the left eye image and the right eye image to be projected, and the second eye image EI2 is the other one of the left eye image and the right eye image to be projected. In addition, the first eye image EI1 includes multiple first pixel groups, the second eye image EI2 includes multiple second pixel groups, and each of the first pixel groups and each of the second pixel groups respectively include a first pixels, a second pixel, a third pixel, and a fourth pixel.

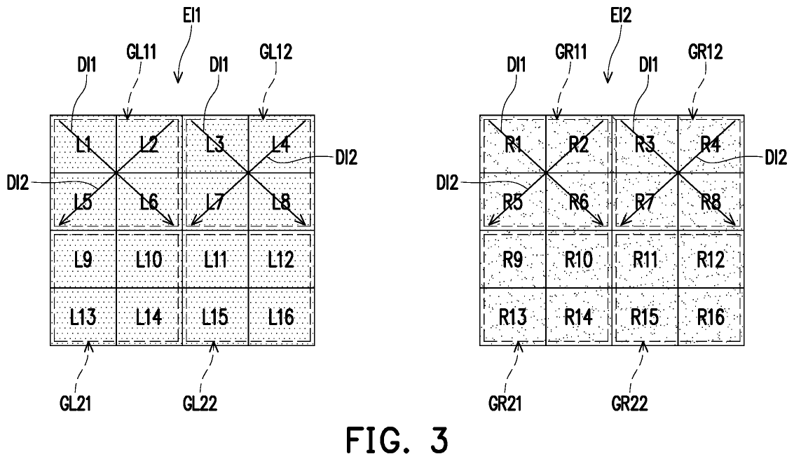

Referring to FIG. 3, FIG. 3 is a schematic diagram of a first eye image and a second eye image according to an embodiment of the present disclosure. To illustrate the concept of the present disclosure, the resolutions of the first eye image EI1 and the second eye image EI2 in FIG. 3 are respectively assumed to be 4×4. In other embodiments, the concept of the present disclosure is applicable to the first eye image EI1 and the second eye image EI2 with other resolutions (such as 4K or higher), and is not limited to the configuration shown in FIG. 3.

In FIG. 3, it is assumed that the first eye image EI1 includes first eye pixels L1 to L16, the second eye image EI2 includes second eye pixels R1 to R16. In this embodiment, the first eye pixels L1 to L16 may be divided into the first pixel groups GL11, GL12, GL21, and GL22, and the second eye pixels R1 to R16 may be divided into the second pixel groups GR11, GR12, GR21, and GR22.

In FIG. 3, each of the first pixel groups GL11, GL12, GL21, and GL22 and each of the second pixel groups GR11, GR12, GR21, and GR22 includes a first pixel, a second pixel, a third pixel, and a fourth pixel.

In one embodiment, the image processing device 103 may determine the content of each of the first pixel groups GL11, GL12, GL21, and GL22 and each of the second pixel groups GR11, GR12, GR21, and GR22 in a specific manner.

Taking the first pixel group GL11 as an example, the first pixel, the second pixel, the third pixel, and the fourth pixel therein may be arranged into a 2×2 pixel array. In addition, the first pixel and the third pixel in the first pixel group GL11 are arranged along a first diagonal direction DI1, and the second pixel and the fourth pixel in the first pixel group GL11 are arranged along a second diagonal direction DI2 perpendicular to the first diagonal direction DI1. In FIG. 3, the first pixel, the second pixel, the third pixel, and the fourth pixel in the first pixel group GL11 are respectively, for example, the first eye pixels L1, L2, L6, and L5.

Taking the first pixel group GL12 as an example, the first pixel, the second pixel, the third pixel, and the fourth pixel therein may be arranged into a 2×2 pixel array. In addition, the first pixel and the third pixel in the first pixel group GL12 are arranged along the first diagonal direction DI1, and the second pixel and the fourth pixel in the first pixel group GL12 are arranged along the second diagonal direction DI2 perpendicular to the first diagonal direction DI1. In FIG. 3, the first pixel, the second pixel, the third pixel, and the fourth pixel in the first pixel group GL12 are respectively, for example, the first eye pixels L3, L4, L8, and L7.

Based on the above teachings, those skilled in the art should be able to deduce that the first pixel, the second pixel, the third pixel, and the fourth pixel in the first pixel group GL21 are respectively, for example, the first eye pixels L9, L10, L14, and L13, and the first pixel, the second pixel, the third pixel, and the fourth pixel in the first pixel group GL22 are respectively, for example, the first eye pixels L11, L12, L16, and L15, the details of which are not repeated herein.

In an embodiment, the image processing device 103 may determine the content of each of the second pixel groups GR11, GR12, GR21, and GR22 in a specific manner.

Taking the second pixel group GR11 as an example, the first pixel, the second pixel, the third pixel, and the fourth pixel therein may be arranged into a 2×2 pixel array. In addition, the first pixel and the third pixel in the second pixel group GR11 are arranged along the first diagonal direction DI1, and the second pixel and the fourth pixel in the second pixel group GR11 are arranged along the second diagonal direction DI2 perpendicular to the first diagonal direction DI1. In FIG. 3, the first pixel, the second pixel, the third pixel, and the fourth pixel in the second pixel group GR11 are respectively, for example, the second eye pixels R1, R2, R6, and R5.

Taking the second pixel group GR12 as an example, the first pixel, the second pixel, the third pixel, and the fourth pixel therein may be arranged into a 2×2 pixel array. In addition, the first pixel and the third pixel in the second pixel group GR12 are arranged along the first diagonal direction DI1, and the second pixel and the fourth pixel in the second pixel group GR12 are arranged along the second diagonal direction DI2 perpendicular to the first diagonal direction DI1. In FIG. 3, the first pixel, the second pixel, the third pixel, and the fourth pixel in the second pixel group GR12 are respectively, for example, the second eye pixels R3, R4, R8, and R7.

Based on the above teachings, those skilled in the art should be able to deduce that the first pixel, the second pixel, the third pixel, and the fourth pixel in the second pixel group GR21 are respectively, for example, the second eye pixels R9, R10, R14, and R13, and the first pixel, the second pixel, the third pixel, and the fourth pixel in the second pixel group GR22 are respectively, for example, the second eye pixels R11, R12, R16, and R15, the details of which are not repeated herein.

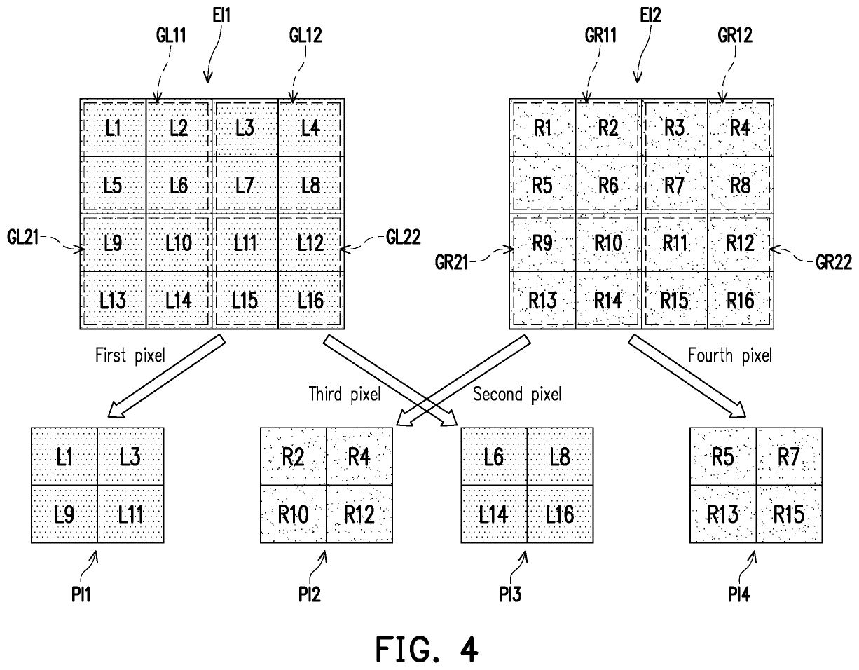

After obtaining the first eye image EI1 and the second eye image EI2, the image processing device 103 may continue to execute steps S220 to S250 to generate the first projection image PI1, the second projection image PI2, the third projection image PI3, and the fourth projection image PI4 accordingly. For ease of understanding, a further description is provided below with reference to FIG. 4.

Referring to FIG. 4, FIG. 4 is a schematic diagram of generating a projection image based on the first eye image and the second eye image shown in FIG. 3. In this embodiment, after obtaining the first eye image EI1 and the second eye image EI2 in FIG. 3, the image processing device 103 executes step S220 to generate a first projection image PI1 based on multiple first pixels of the multiple first pixel groups GL11, GL12, GL21, and GL22.

For example, the image processing device 103 may extract the first pixels in each of the first pixel groups GL11, GL12, GL21, and GL22 to form the first projection image PI1. In the scenario of FIG. 3 and FIG. 4, it is assumed that the first pixel of the first pixel group GL11 is the first eye pixel L1, the first pixel of the first pixel group GL12 is the first eye pixel L3, the first pixel of the first pixel group GL21 is the first eye pixel L9, and the first pixel of the first pixel group GL22 is the first eye pixel L11. In this case, the image processing device 103 may combine the first eye pixels L1, L3, L9, and L11 into a first projection image PI1.

From another point of view, the image processing device 103 may also be understood as extracting the upper left pixel of each of the first pixel groups GL11, GL12, GL21, and GL22 to form the first projection image PI1 accordingly, but not limited thereto.

In step S230, the image processing device 103 generates a second projection image PI2 based on multiple second pixels of the multiple second pixel groups GR11, GR12, GR21, and GR22.

For example, the image processing device 103 may extract the second pixels in each of the second pixel groups GR11, GR12, GR21, and GR22 to form the second projection image PI2. In the scenario of FIG. 3 and FIG. 4, it is assumed that the second pixel of the second pixel group GR11 is the second eye pixel R2, the second pixel of the second pixel group GR12 is the second eye pixel R4, the second pixel of the second pixel group GR21 is the second eye pixel R10, and the second pixel of the second pixel group GR22 is the second eye pixel R12. In this case, the image processing device 103 may combine the second eye pixels R2, R4, R10, and R12 into a second projection image PI2.

From another point of view, the image processing device 103 may also be understood as extracting the upper right pixel of each of the second pixel groups GR11, GR12, GR21, and GR22 to form the second projection image PI2 accordingly, but not limited thereto.

In step S240, the image processing device 103 generates a third projection image PI3 based on multiple third pixels of the multiple first pixel groups GL11, GL12, GL21, and GL22.

For example, the image processing device 103 may extract the third pixels in each of the first pixel groups GL11, GL12, GL21, and GL22 to form the third projection image PI3. In the scenario of FIG. 3 and FIG. 4, it is assumed that the third pixel of the first pixel group GL11 is the first eye pixel L6, the third pixel of the first pixel group GL12 is the first eye pixel L8, the third pixel of the first pixel group GL21 is the first eye pixel L14, and the third pixel of the first pixel group GL22 is the first eye pixel L16. In this case, the image processing device 103 may combine the first eye pixels L6, L8, L14, and L16 into a third projection image PI3.

From another point of view, the image processing device 103 may also be understood as extracting the lower right pixel of each of the first pixel groups GL11, GL12, GL21, and GL22 to form the third projection image PI3 accordingly, but not limited thereto.

In step S250, the image processing device 103 generates a fourth projection image PI4 based on multiple fourth pixels of the multiple second pixel groups GR11, GR12, GR21, and GR22.

For example, the image processing device 103 may extract the fourth pixels in each of the second pixel groups GR11, GR12, GR21, and GR22 to form the fourth projection image PI4. In the scenario of FIG. 3 and FIG. 4, it is assumed that the fourth pixel of the second pixel group GR11 is the second eye pixel R5, the fourth pixel of the second pixel group GR12 is the second eye pixel R7, the fourth pixel of the second pixel group GR21 is the second eye pixel R13, and the fourth pixel of the second pixel group GR22 is the second eye pixel R15. In this case, the image processing device 103 may combine the second eye pixels R5, R7, R13, and R15 into a fourth projection image PI4.

From another point of view, the image processing device 103 may also be understood as extracting the lower left pixel of each of the second pixel groups GR11, GR12, GR21, and GR22 to form the fourth projection image PI4 accordingly, but not limited thereto.

It should be understood that although the steps S220 to S250 are shown as being executed sequentially in FIG. 2, in other embodiments, the execution order of the steps S220 to S250 may be adjusted according to the requirements of the designer. In an embodiment, the steps S220 to S250 may also be executed simultaneously, but not limited thereto.

After generating the first projection image PI1, the second projection image PI2, the third projection image PI3, and the fourth projection image PI4, in step S260, the image shifting device 104 sequentially projects the first projection image PI1, the second projection image PI2, the third projection image PI3, and the fourth projection image PI4. The first projection image PI1 and the third projection image PI3 correspond to the first eye image EI1, and the second projection image PI2 and fourth projection image PI4 correspond to the second eye image EI2.

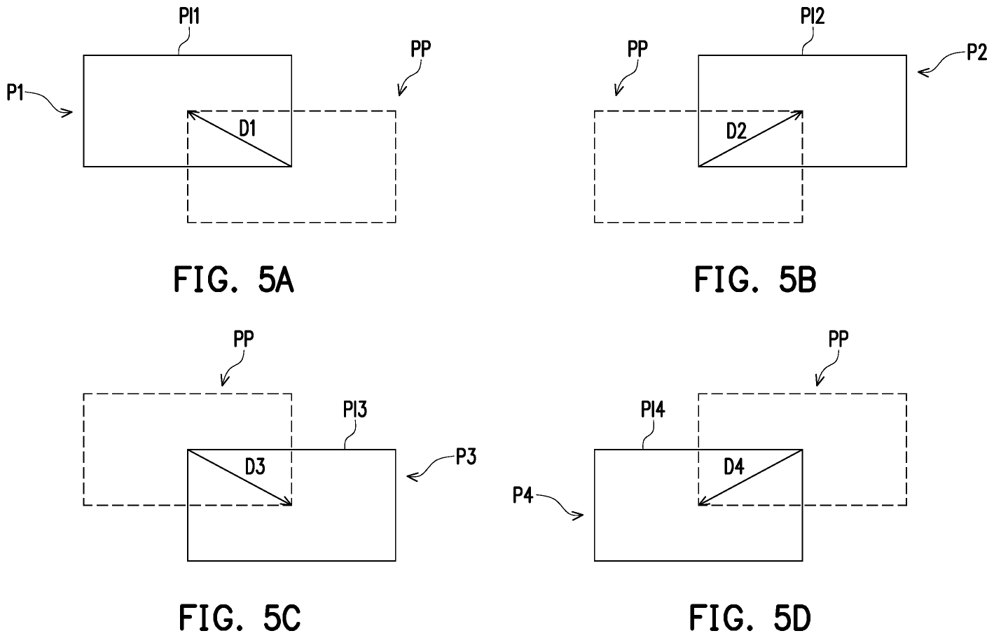

Referring to FIG. 5A to FIG. 5D, FIG. 5A to FIG. 5D are schematic diagrams of projecting multiple projection images according to FIG. 4.

In FIG. 5A, the image shifting device 104 shifts the first projection image PI1 to the first position P1 along the first direction D1. In one embodiment, the image shifting device 104 may shift the first projection image PI1 to the first position P1 by, for example, adjusting the configuration of the four-way actuator. In this embodiment, the image shifting device 104 may shift the first projection image PI1 from the preset position PP to the first position P1 along the first direction D1. In this case, the shifted first projection image PI1 may be further projected onto the corresponding projection surface through the projection lens 106.

In FIG. 5B, the image shifting device 104 shifts the second projection image PI2 to the second position P2 along the second direction D2. In one embodiment, the image shifting device 104 may shift the second projection image PI2 to the second position P2 by, for example, adjusting the configuration of the four-way actuator. In this embodiment, the image shifting device 104 may shift the second projection image PI2 from the preset position PP to the second position P2 along the second direction D2. In this case, the shifted second projection image PI2 may be further projected onto the corresponding projection surface through the projection lens 106.

In FIG. 5C, the image shifting device 104 shifts the third projection image PI3 to the third position P3 along the third direction D3. In one embodiment, the image shifting device 104 may shift the third projection image PI3 to the third position P3 by, for example, adjusting the configuration of the four-way actuator. In this embodiment, the image shifting device 104 may shift the third projection image PI3 from the preset position PP to the third position P3 along the third direction D3. In this case, the shifted third projection image PI3 may be further projected onto the corresponding projection surface through the projection lens 106.

In FIG. 5D, the image shifting device 104 shifts the fourth projection image PI4 to the fourth position P4 along the fourth direction D4. In one embodiment, the image shifting device 104 may shift the fourth projection image PI4 to the fourth position P4 by, for example, adjusting the configuration of the four-way actuator. In this embodiment, the image shifting device 104 may shift the fourth projection image PI4 from the preset position PP to the fourth position P4 along the fourth direction D4. In this case, the shifted fourth projection image PI4 may be further projected onto the corresponding projection surface through the projection lens 106.

In addition, in FIG. 5A to FIG. 5D, the second direction D2 is perpendicular to the first direction D1, the third direction D3 is opposite to the first direction D1, and the fourth direction D4 is opposite to the second direction D2.

In an embodiment, the first projection image PI1, the second projection image PI2, the third projection image PI3, and the fourth projection image PI4 may have the same shifted distance. That is, the distances between each of the first position P1, the second position P2, the third position P3 and the fourth position P4 and the preset position PP are all equal, but not limited thereto.

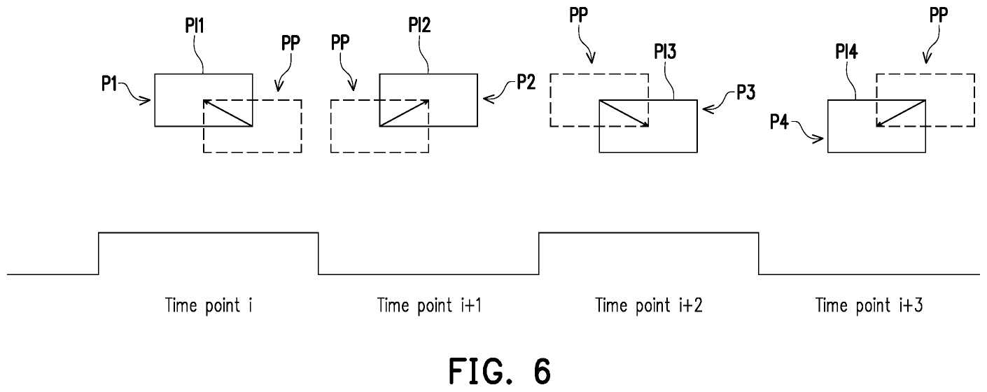

In one embodiment, the image shifting device 104 may perform the operations shown in FIG. 5A to FIG. 5D in sequence. Referring to FIG. 6, FIG. 6 is a schematic diagram of sequentially projecting multiple projection images according to FIG. 5A to FIG. 5D.

In FIG. 6, the image shifting device 104 performs the following operation. The first projection image PI1 is shifted to the first position P1 at a time point i (i is a time index value). The second projection image PI2 is shifted to the second position P2 at a time point i+1. The third projection image PI3 is shifted to the third position P3 at a time point i+2. The fourth projection image PI4 is shifted to the fourth position P4 at a time point i+3.

In one embodiment, in response to the first projection image PI1 being shifted to the first position P1, the image processing device 103 controls the 3D glasses to enable the first lens (e.g., the left eye lens) corresponding to the first eye (e.g., the left eye) of the user, and disable the second lens (e.g., the right eye lens) corresponding to the second eye (e.g., the right eye) of the user. In FIG. 6, the image processing device 103 may, for example, enable the first lens and disable the second lens at time point i. In this way, the user may only see the shifted first projection image PI1 through the first eye.

In one embodiment, in response to the second projection image PI2 being shifted to the second position P2, the image processing device 103 controls the 3D glasses to disable the first lens corresponding to the first eye and enable the second lens corresponding to the second eye. In FIG. 6, the image processing device 103 may for example, enable the second lens and disable the first lens at time point i+1. In this way, the user may only see the shifted second projection image PI2 through the second eye.

In one embodiment, in response to the third projection image PI3 being shifted to the third position P3, the image processing device 103 controls the 3D glasses to enable the first lens corresponding to the first eye and disable the second lens corresponding to the second eye. In FIG. 6, the image processing device 103 may for example, enable the first lens and disable the second lens at time point i+2. In this way, the user may only see the shifted third projection image PI3 through the first eye.

In one embodiment, in response to the fourth projection image PI4 being shifted to the fourth position P4, the image processing device 103 controls the 3D glasses to disable the first lens corresponding to the first eye and enable the second lens corresponding to the second eye. In FIG. 6, the image processing device 103 may for example, enable the second lens and disable the first lens at time point i+3. In this way, the user may only see the shifted fourth projection image PI4 through the second eye.

In an embodiment, the time difference between adjacent time points in FIG. 6 may be less than 1/120 second. That is, the 3D projection device 100 may project the shifted first projection image PI1, second projection image PI2, third projection image PI3, and fourth projection image PI4 at a frequency higher than 120 Hz. In this way, the persistence of vision phenomenon may appear in the eyes of the user wearing the 3D glasses, so that the user may view the 3D display content projected by the 3D projection device 100.

In addition, as shown in FIG. 4, the first pixel and the third pixel of each of the first pixel groups GL11, GL12, GL21, and GL22 are arranged diagonally (e.g., the first eye pixels L1 and L6 in the first pixel group GL11), and the first pixel and the third pixel of the first pixel groups GL11, GL12, GL21, and GL22 are respectively sampled to form the first projection image PI1 and the third projection image PI3. In this case, according to the Pythagorean theorem, the resolution jointly provided by the first projection image PI1 and the third projection image PI3 is only decreased by √2 times compared with the first eye image EI1. For example, assuming that the resolution of the first eye image EI1 is 3840*2160, the resolution jointly provided by the first projection image PI1 and the third projection image PI3 is 2712*1528, where 2712 is equivalent to 3840/√2, and 1528 is equivalent to 2160/√2.

Similarly, the second pixel and the fourth pixel of each of the second pixel groups GR11, GR12, GR21, and GR22 are arranged diagonally (e.g., the second eye pixels R2 and R5 in the second pixel group GR11), and the second pixel and the fourth pixel of the second pixel groups GR11, GR12, GR21, and GR22 are respectively sampled to form the second projection image PI2 and the fourth projection image PI4. In this case, according to the Pythagorean theorem, the resolution jointly provided by the second projection image PI2 and the fourth projection image PI4 is only decreased by √2 times compared with the second eye image EI2. For example, assuming that the resolution of the second eye image EI2 is 3840*2160, the resolution jointly provided by the second projection image PI2 and the fourth projection image PI4 is 2712*1528, wherein 2712 is equivalent to 3840/√2, and 1528 is equivalent to 2160/√2.

It may be seen that, compared with the conventional method, the method proposed in the embodiment of the present disclosure may achieve good resolution without reducing the projection frequency.

To sum up, in the method of the embodiment of the present disclosure, after obtaining the first eye image (and each of the first pixel groups therein) and the second eye image (and each of the second pixel groups therein), the pixels in each of the first pixel groups and second pixel groups may be used to form different projection images, and the projection images corresponding to both eyes of the user are projected in turn. In this way, the effect of residual vision may be achieved in the eyes of the user, so that the user may enjoy the experience of viewing 3D projection content with good resolution.

However, the above are only preferred embodiments of the disclosure and are not intended to limit the scope of the disclosure; that is, all simple and equivalent changes and modifications made according to the claims and the contents of the disclosure are still within the scope of the disclosure. In addition, any of the embodiments or the claims of the disclosure are not required to achieve all of the objects or advantages or features disclosed herein. In addition, the abstract and title are provided to assist in the search of patent documents and are not intended to limit the scope of the disclosure. In addition, the terms “first,” “second” and the like mentioned in the specification or the claims are used only to name the elements or to distinguish different embodiments or scopes and are not intended to limit the upper or lower limit of the number of the elements.

The foregoing description of the preferred embodiments of the disclosure has been presented for purposes of illustration and description. It is not intended to be exhaustive or to limit the disclosure to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the disclosure and its best mode practical application, thereby to enable persons skilled in the art to understand the disclosure for various embodiments and with various modifications as are suited to the particular use or implementation contemplated. It is intended that the scope of the disclosure be defined by the claims appended hereto and their equivalents in which all terms are meant in their broadest reasonable sense unless otherwise indicated. Therefore, the term “the disclosure”, “the present disclosure” or the like does not necessarily limit the claim scope to a specific embodiment, and the reference to particularly preferred exemplary embodiments of the disclosure does not imply a limitation on the disclosure, and no such limitation is to be inferred. The disclosure is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the disclosure. It should be appreciated that variations may be made in the embodiments described by persons skilled in the art without departing from the scope of the present disclosure as defined by the following claims. Moreover, no element and component in the present disclosure is intended to be dedicated to the public regardless of whether the element or component is explicitly recited in the following claims.

What is claimed is:

1. A 3D projection method, adapted to a 3D projection device, comprising steps of:
obtaining a first eye image and a second eye image by the 3D projection device, wherein the first eye image comprises a plurality of first pixel groups, the second eye image comprises a plurality of second pixel groups, and each of the plurality of first pixel groups and each of the plurality of second pixel groups comprises a first pixel, a second pixel, a third pixel, and a fourth pixel;
generating a first projection image by the 3D projection device based on the first pixels of the plurality of first pixel groups;
generating a second projection image by the 3D projection device based on the second pixels of the plurality of second pixel groups;
generating a third projection image by the 3D projection device based on the third pixels of the plurality of first pixel groups;
generating a fourth projection image by the 3D projection device based on the fourth pixels of the plurality of second pixel groups; and
sequentially projecting the first projection image, the second projection image, the third projection image, and the fourth projection image by the 3D projection device, wherein the first projection image and the third projection image correspond to the first eye image, the second projection image and the fourth projection image correspond to the second eye image, the first eye image is one of a left eye image and a right eye image, and the second eye image is another one of the left eye image and the right eye image.

2. The 3D projection method according to claim 1, wherein the first pixel, the second pixel, the third pixel, and the fourth pixel in each of the plurality of first pixel groups and each of the plurality of second pixel groups are arranged into a 2×2 pixel array, the first pixel and the third pixel in each of the plurality of first pixel groups and each of the plurality of second pixel groups are arranged along a first diagonal direction, and the second pixel and the fourth pixel in each of the plurality of first pixel groups and each of the plurality of second pixel groups are arranged along a second diagonal direction perpendicular to the first diagonal direction.

3. The 3D projection method according to claim 1, wherein the step of sequentially projecting the first projection image, the second projection image, the third projection image, and the fourth projection image comprises:
shifting the first projection image to a first position along a first direction by controlling an image shifting device of the 3D projection device;
shifting the second projection image to a second position along a second direction by controlling the image shifting device of the 3D projection device;
shifting the third projection image to a third position along a third direction by controlling the image shifting device of the 3D projection device; and
shifting the fourth projection image to a fourth position along a fourth direction by controlling the image shifting device of the 3D projection device.

4. The 3D projection method according to claim 3, wherein the first projection image, the second projection image, the third projection image, and the fourth projection image have a same shifted distance.

5. The 3D projection method according to claim 3, wherein the second direction is perpendicular to the first direction, the third direction is opposite to the first direction, and the fourth direction is opposite to the second direction.

6. The 3D projection method according to claim 3, further comprising a step of:
shifting the first projection image from a preset position to the first position along the first direction, shifting the second projection image from the preset position to the second position along the second direction, shifting the third projection image from the preset position to the third position along the third direction, and shifting the fourth projection image from the preset position to the fourth position along the fourth direction by controlling the image shifting device of the 3D projection device.

7. The 3D projection method according to claim 3, further comprising a step of:
in response to the first projection image being shifted to the first position, controlling a pair of 3D glasses to enable a first lens corresponding to the first eye and disable a second lens corresponding to the second eye;
in response to the second projection image being shifted to the second position, controlling the pair of 3D glasses to disable the first lens corresponding to the first eye and enable the second lens corresponding to the second eye;
in response to the third projection image being shifted to the third position, controlling the pair of 3D glasses to enable the first lens corresponding to the first eye and disable the second lens corresponding to the second eye; and
in response to the fourth projection image being shifted to the fourth position, controlling the pair of 3D glasses to disable the first lens corresponding to the first eye and enable the second lens corresponding to the second eye.

8. A 3D projection device, comprising:
an image processing device, configured to perform:
obtaining a first eye image and a second eye image, wherein the first eye image comprises a plurality of first pixel groups, the second eye image comprises a plurality of second pixel groups, and each of the plurality of first pixel groups and each of the plurality of second pixel groups comprises a first pixel, a second pixel, a third pixel, and a fourth pixel;
generating a first projection image based on the first pixels of the plurality of first pixel groups;
generating a second projection image based on the second pixels of the plurality of second pixel groups;
generating a third projection image based on the third pixels of the plurality of first pixel groups;
generating a fourth projection image based on the fourth pixels of the plurality of second pixel groups; and
an image shifting device, coupled to the image processing device and configured to perform:
sequentially projecting the first projection image, the second projection image, the third projection image, and the fourth projection image, wherein the first projection image and the third projection image correspond to the first eye image, the second projection image and the fourth projection image correspond to the second eye image, the first eye image is one of a left eye image and a right eye image, and the second eye image is another one of the left eye image and the right eye image.

9. The 3D projection device according to claim 8, wherein the first pixel, the second pixel, the third pixel, and the fourth pixel in each of the plurality of first pixel groups and each of the plurality of second pixel groups are arranged into a 2×2 pixel array, the first pixel and the third pixel in each of the plurality of first pixel groups and each of the plurality of second pixel groups are arranged along a first diagonal direction, and the second pixel and the fourth pixel in each of the plurality of first pixel groups and each of the plurality of second pixel groups are arranged along a second diagonal direction perpendicular to the first diagonal direction.

10. The 3D projection device according to claim 8, wherein the image shifting device is configured to perform:
shifting the first projection image to a first position along a first direction;
shifting the second projection image to a second position along a second direction;
shifting the third projection image to a third position along a third direction; and
shifting the fourth projection image to a fourth position along a fourth direction.

11. The 3D projection device according to claim 10, wherein the first projection image, the second projection image, the third projection image, and the fourth projection image have a same shifted distance.

12. The 3D projection device according to claim 10, wherein the second direction is perpendicular to the first direction, the third direction is opposite to the first direction, and the fourth direction is opposite to the second direction.

13. The 3D projection device according to claim 10, wherein the image shifting device is configured to perform:
shifting the first projection image from a preset position to the first position along the first direction, shifting the second projection image from the preset position to the second position along the second direction, shifting the third projection image from the preset position to the third position along the third direction, and shifting the fourth projection image from the preset position to the fourth position along the fourth direction.

14. The 3D projection device according to claim 10, wherein the image processing device is configured to perform:
in response to the first projection image being shifted to the first position, controlling a pair of 3D glasses to enable a first lens corresponding to the first eye and disable a second lens corresponding to the second eye;
in response to the second projection image being shifted to the second position, controlling the pair of 3D glasses to disable the first lens corresponding to the first eye and enable the second lens corresponding to the second eye;
in response to the third projection image being shifted to the third position, controlling the pair of 3D glasses to enable the first lens corresponding to the first eye and disable the second lens corresponding to the second eye; and
in response to the fourth projection image being shifted to the fourth position, controlling the pair of 3D glasses to disable the first lens corresponding to the first eye and enable the second lens corresponding to the second eye.
